(19) United States
(12) Patent Application Publication
(10) Pub. No.: US 2024/0158638 A1
(43) Pub. Date: May 16, 2024

(54) PLANT-BASED FLEXIBLE MATERIAL, PROCESS FOR PREPARATION, AND USES THEREOF

(71) Applicant: Mira Kristina Magnhild NAMETH, London (GB)

(72) Inventor: Mira Kristina Magnhild NAMETH, London (GB)

(21) Appl. No.: 18/549,739

(22) PCT Filed: Mar. 9, 2022
(86) PCT No.: PCT/GB2022/050606

§ 371 Date: Sep. 8, 2023

(30) Foreign Application Priority Data
Mar. 10, 2021 (GB) 2103290.9

(51) Int. Cl. C08L 97/02; C08B 37/00; D06N 3/00

(52) U.S. Cl. CPC C08L 97/02; C08B 37/0042; D06N 3/0015

(57) ABSTRACT

The invention relates to a plant-based flexible material and a process for preparation thereof. The flexible material is useful as an alternative to leather, formed without the use of animal products. In one aspect, the present invention provides a process for preparing a plant-based flexible material, comprising the steps of: a) providing a dispersion of lignocellulosic biomass in an agueous-based solvent and further comprising one or more binders, wherein the one or more binders comprises at least one sulphated polysaccharide; b) heating the dispersion to a temperature of at least 35° C. to form a heated dispersion; and c) drying the heated dispersion to form the flexible material.

The invention relates to a plant-based flexible material and a process for preparation thereof. The flexible material is useful as an alternative to leather, formed without the use of animal products.

### BACKGROUND OF THE INVENTION

Leather is a durable and flexible material created by tanning animal rawhide and skins and has been used for millennia for a host of different purposes. Leather remains a commonly used material for the manufacture of a variety of articles, including footwear, automobile seats, clothing, bags, book bindings, upholstery, fashion accessories, and furniture. Leather usage has, however, come under increased criticism in recent times based on ethical and environmental considerations around the production of leather goods, requiring animals to be reared and slaughtered, thereby also contributing to greenhouse gas emissions. Due to the requirements of rearing animals such as cattle, leather production is responsible for unsustainable water consumption, land usage and waste production. Consequently, there exists a need for alternative flexible materials that are prepared without the use of animal products, i.e. ‘vegan’ materials, that may serve as alternatives and replacements to conventional leather materials.

A known leather replacement is polyvinylchloride (PVC) leather. PVC is a synthetic polymer made from halogenated hydrocarbons. PVC represents an environmental hazard, being made from fossil fuels, including natural gas, and is non-biodegradable and may thus persist in the environment post disposal for around 140 years. Some plant-based leather replacement materials, such as Fabrikoid® and Rexine®, have been known for use in car interiors since as long ago as the 1920s. These are both imitation leather materials (e.g. “faux leather”) made by the coating of cloths with nitrocellulose. Whilst the cloths may be derived from plant-based sources such as cotton, and the nitrocellulose is also plant derived, the use and manufacture of nitrocellulose represents a significant safety and environmental hazard. Cotton is also a highly undesirable material from an environmental viewpoint. The water footprint of 1 kg of cotton is around 10,000 litres, leading to widespread mismanagement of water resources as a consequence of cotton production. Pifiatex® is a natural leather alternative made from cellulose fibres extracted from pineapple leaves mixed with PLA (polylactic acid) and petroleum-based resin. However, the use of petroleum resins prevents the material from biodegrading and thus is undesirable from an environmental perspective.

More environmentally friendly plant-based leather materials are known in the art, such as those disclosed in CN110344276 (A), which describes the moulding of plant pulp into a desired shape followed by coating with a biological resin. Nevertheless, in view of increased pressures to produce more sustainable materials and for the re-purposing of waste materials, there remains a need for alternative ‘vegan’ or plant-based flexible materials that are both biodegradable and can be produced from a wide range of renewable feedstocks.

### SUMMARY OF THE INVENTION

The present invention is based on the discovery that plant-based flexible materials exhibiting a variety of desirable properties, that make the materials suitable for use in a wide range of applications, including, for example, in clothing, shoes, fashion accessories, construction materials, fabrics, vehicle interiors or seating, and upholstery, may be prepared from lignocellulosic biomass and one or more binders comprising at least one sulphated polysaccharide. It has, in particular, been surprisingly found that the inclusion of at least one sulphated polysaccharide binder can impart highly beneficial properties onto a plant-based flexible material derived from lignocellulosic biomass.

Thus, in one aspect, the present invention provides a process for preparing a plant-based flexible material, comprising the steps of:
a) providing a dispersion of lignocellulosic biomass in an aqueous-based solvent and further comprising one or more binders, wherein the one or more binders comprises at least one sulphated polysaccharide;
b) heating the dispersion to a temperature of at least 35° C. to form a heated dispersion; and
c) drying the heated dispersion to form the flexible material.

In another aspect, the present invention provides a plant-based flexible material prepared, or preparable, by the methods described herein.

In a further aspect, the present invention provides a plant-based flexible material comprising lignocellulosic biomass, one or more binders, and optionally one or more plasticisers, wherein the one or more binders includes at least one sulphated polysaccharide.

In yet a further aspect, the present invention provides the use of a sulphated polysaccharide, preferably a carrageenan (e.g. kappa carrageenan), as a binder in a plant-based flexible material.

### BRIEF DESCRIPTION OF THE FIGURES

FIG. 1 illustrates a sample of the flexible material produced in Example 1;

FIG. 2 illustrates a sample of the flexible material produced in Example 1 with particular regard to the surface finish;

FIG. 3 illustrates a cross sectional view of the flexible material produced in Example 1:

FIG. 4 illustrates a sample of the flexible material produced in Example 1 at ×40 magnification;

FIG. 5 illustrates a sample of the flexible material produced in Example 1 at ×100 magnification;

FIG. 6 illustrates a comparative sample of leather at ×40 magnification;

FIG. 7 illustrates a comparative sample of leather at ×100 magnification;

FIG. 8 illustrates a comparative sample of PVC leather at ×40 magnification;

FIG. 9 illustrates a comparative sample of PVC leather at ×100 magnification;

FIG. 10 illustrates a sample of the flexible material produced in Example 2 at ×40 magnification;

FIG. 11 illustrates a sample of the flexible material produced in Example 2 at ×100 magnification;

FIG. 12 illustrates a sample of the flexible material produced in Example 3 at ×40 magnification;

FIG. 13 illustrates a sample of the flexible material produced in Example 3 at ×100 magnification;

FIG. 14 illustrates a sample of the flexible material produced in Example 4 at ×40 magnification;

FIG. 15 illustrates a sample of the flexible material produced in Example 4 at ×100 magnification;

FIG. 16 illustrates a typical dispersion of lignocellulosic biomass provided in step a) prior to the heating provided in step b); and

FIG. 17 illustrates a typical heated dispersion formed by the heating of step b) at 60° C. in which gelation can be seen to have occurred.

### DETAILED DESCRIPTION

Reference herein to a “plant-based flexible material” refers to a solid material which is at least partially derived from, or preferably substantially or exclusively derived from, plant matter. The material is capable of being deformed by an applied force (for example a tensile, bending, compressive, twisting force etc) that may be encountered during use in applications such as in clothing, shoes, fashion accessories, construction materials, fabrics, vehicle interiors or seating, and upholstery and returning substantially to its original form, following removal of the applied force and/or application of a counter force. Flexibility, in the context of this disclosure, thus has its usual meaning as being opposite to stiffness (which is instead characterised by an ability of a material to resist deformation in response to an applied force). The plant-based flexible materials of the present invention thus are suitable for use in numerous applications for example, in clothing, shoes, fashion accessories, construction materials, fabrics (for example, tents), vehicle interiors or seating (for example, cars, other road vehicles, aircraft or spacecraft) or upholstery. As will be appreciated, such applications require materials to have particular properties of tensile strength, elongation, durability, abrasion resistance, UV resistance, air permeability, and vapor permeability, to various extents depending on particular application, all of which may be achieved by the flexible materials of the present invention.

The flexibility of a flexible material, in the context of this disclosure, is preferably defined as having a stiffness of from 1 to 1000 mg·cm, preferably of from 10 to 900 mg·cm, more preferably of from 30 to 800 mg·cm, even more preferably from 40 to 700 mg·cm, even more preferably from 50 to 600 mg·cm, even more preferably from 60 to 500 mg·cm, even more preferably from 70 to 400 mg·cm, even more preferably from 80 to 350 mg·cm, even more preferably from 90 to 300 mg·cm, even more preferably from 100 to 250 mg·cm, even more preferably from 150 to 200 mg·cm, as measured using ASTM D1388.

Reference herein to “lignocellulosic biomass” refers to any plant matter (for example, raw plant matter) or material derived therefrom as a result of physical and/or chemical processing performed on the plant matter. Lignocellulosic biomass is composed of varying proportions of cellulose, hemicellulose, and lignin. Examples of lignocellulosic biomass useful in the present invention include all forms of plant matter including leaves/needles, twigs/branches, grass, bark, roots, flowers, seeds, stalks, stems, strobili, lignocellulosic food manufacturing waste, materials derived therefrom (for example wood chips) and combinations thereof. Preferably, the lignocellulosic biomass useful in the present invention includes leaves/needles (for example, derived from Plane, Poplar, Oak, Maple, Wisteria, Conifer), bark (for example, derived from Plane), twigs/branches (for example, derived from Plane, Bamboo, conifer), grass, lignocellulosic food manufacturing waste (for example, vegetables, grains, peels and nuts) and combinations thereof. More preferably, the lignocellulosic biomass useful in the present invention includes leaf/needles and/or twigs/branches. Most preferably, the lignocellulosic biomass useful in the present invention includes leaf/needles and twigs/branches in a weight ratio of from 10:1 to 1:10.

The present invention provides a process for preparing a plant-based flexible material, as well as a plant-based flexible material prepared or preparable by the methods disclosed herein. In the process of the present invention, a dispersion of lignocellulosic biomass in an aqueous-based solvent, which dispersion further comprises one or more binders, including at least one sulphated polysaccharide binder, is first provided.

The dispersion of lignocellulosic biomass may be prepared simply by mixing particles and/or fibres of lignocellulosic biomass with an aqueous-based solvent and one or more binders, in any order. Mixing may be achieved by methods known in the art, such as shaking or stirring, and may be achieved by hand (depending on scale) or preferably by mechanical means. It will be appreciated that particles of lignocellulosic biomass useful for preparing a dispersion should be appropriately sized to ensure retention of the dispersion once formed and preferably allow for flowability of the dispersion for further processing. Typical particle sizes of lignocellulosic biomass useful in preparing the dispersion include those having a particle size of 5 mm or less, although larger particulates may be accommodated to a varying degree, whilst still being capable of being dispersed (e.g. avoid settling out over a time period of at least 3 days, preferably at least 1 week). Thus, in embodiments, at least 75 vol. %, preferably at least 90 vol. %, more preferably at least 95 vol. %, of particles of lignocellulosic biomass used for preparing the dispersion in accordance with the present invention will have a particle size of 5 mm or less, and the remainder will preferably have a particle size of less than 10 mm.

As will be appreciated, fibres of lignocellulosic biomass may have varying lengths and be suitable for preparing a dispersion in accordance with the present invention. Typical cross-sectional diameters of fibres that may be used in forming the dispersion of the present invention will be less than 4 mm, preferably less than 2 mm, more preferably less than 1 mm, even more preferably less than 0.5 mm. In embodiments, cross-sectional diameters of fibres that may be used in forming the dispersion of the present invention may range from 40 μm to 4 mm, preferably from 100 μm to 3 mm, more preferably from 200 μm to 2 mm. Typically, the length of the fibres that may be used in the forming of the dispersion of the present invention is much greater than the cross sectional diameter. For example, a fibre may be greater than 10 times longer than its cross-sectional diameter, a fibre may also be up to 100 times longer than its cross-sectional diameter, a fibre may even be up to 1000 times longer than its cross-sectional diameter.

Particles of lignocellulosic biomass can be prepared from any of the sources of lignocellulosic biomass described herein by methods known in the art, for example grinding, shredding or milling, the particles size may also be controlled by known methods, for example sifting, sieving through a predetermined mesh size, centrifugation, sedimentation or gravity separation. Lignocellulosic biomass from any of the sources described herein may be processed into the form of a powder, granules, pellets, paste and/or fibres, prior to combination with the aqueous-based solvent. Alternatively or additionally, a dispersion of lignocellulosic biomass in an aqueous-based solvent may be obtained directly from various sources without the need for pre-mixing. Directly acquired dispersions of lignocellulosic biomass in an aqueous-based solvent may include various forms of organic waste, for example compost, waste pulp from juice production, and household or commercial waste. It will be appreciated that the addition of further aqueous-based solvent may be required in the case of very concentrated dispersions. Preferably, the volume ratio of aqueous-based solvent to lignocellulosic biomass in the dispersion is from 5:1 to 20:1 and more preferably from 10:1 to 15:1.

Granules of lignocellulosic biomass according to the present invention correspond to discrete particles, or agglomerates thereof, of lignocellulosic biomass, which typically have a median particle size diameter (d50) of 1,000 μm or greater, for example a median particle size diameter (d50) of 1,000 μm to 5,000 μm. The terms granular material and granules are used interchangeably herein. As will be appreciated, granules useful in the present invention may not have regular or uniform size and shape but there is no particular limitation provided that they may be used to form a stable dispersion with the aqueous-based solvent (e.g. avoid settling out over a time period of at least 3 days, preferably at least 1 week).

Powders of lignocellulosic biomass according to the present invention have a median particle size diameter (d50) of less than 1000 μm, preferably less than 800 μm. Examples of suitable median particle size diameters (d50) for powders useful in the present invention include, less than 700 μm, less than 600 μm or less than 500 μm. In preferred embodiments, lignocellulosic powder useful in the present invention has a median particle size diameter (d50) of from 10 to 700 μm, preferably from 20 μm to 600 μm, more preferably from 50 μm to 500 μm, or most preferably from 100 μm to 300 μm. In some embodiments, lignocellulosic powder useful in the present invention has a median particle size diameter (d50) of less than 10 μm. Smaller median particle size diameter (d50) tends to provide a flexible material with a better appearance. Particle size diameter (d50) may suitably be determined by means of a laser diffraction particle size analyser (e.g. a Microtrac S3500 Particle size analyser).

Pellets referred to herein correspond to a compressed form of the granular and/or powder materials described above. A pellet may be formed into a variety of shapes, including disc, cylindrical or capsular shapes, and may be used in the preparation of a dispersion following break-up on combining with the aqueous-based solvent.

A paste is a mixture of fine particles and a liquid, but without sufficient liquid to allow the paste to have good flowability. A paste of lignocellulosic biomass is herein defined as a combination of lignocellulosic biomass particulate such as a powder, granules, pellets and/or fibres, mulled with a liquid, for example an aqueous-based solvent, without possessing good mobility or flowability.

A fibre is a substance that is significantly longer than it is wide. Fibres are present in many types of plant matter. As will be appreciated, some common methods of processing lignocellulosic biomass (e.g. by grinding, shredding or milling) may not remove fibres (or convert to finer particulate). Fibres may therefore persist in processed lignocellulosic biomass and dispersions thereof. Methods of separating larger particles from finer particles e.g. sieving may also not remove all fibres (such as those having a smaller cross sectional-diameter than that of the holes in the sieve). It is therefore possible that the lignocellulosic biomass provided in any of the forms described herein may further comprise fibres. This is not believed to lead to any detrimental effect for preparing a flexible material in accordance with the present invention, although it is preferable that the majority (e.g. greater than 50 wt. %, preferably greater than 75 wt. %) of the lignocellulosic biomass is in particulate form (such as powder form) when used in the preparation of the dispersion.

In some embodiments, the process comprises a preceding step wherein lignocellulosic biomass from any of the sources described herein is processed to be in the form of a powder, granules, pellets, paste and/or fibres, and is subsequently combined with the aqueous-based solvent as part of providing the dispersion. Methods of processing lignocellulosic biomass in the form of powder, granules, pellets, paste and/or fibres include grinding, shredding or milling. These processes are well known in the art and can be performed with commercially available machinery such as grinder mills, commercial food and herb pulverisers or grinders. A detailed review of comminution of lignocellulosic biomass can, for instance, be found in Mayer-Laigle C, et al Comminution of Dry Lignocellulosic Biomass, a Review: Part I. From Fundamental Mechanisms to Milling Behaviour, Bioengineering (Basel)., 2018, 5, 2, 41. and Mayer-Laigle C, et al, Comminution of Dry Lignocellulosic Biomass: Part II. Technologies, Improvement of Milling Performances, and Security Issues, Bioengineering (Basel)., 2018, 5, 3, 50.

In some embodiments the powder, granules, pellets, paste and/or fibres formed in this step are washed and then dehydrated, prior to combination with the aqueous-based solvent to provide the dispersion. Washing typically comprises contacting the powder, granules, pellets, paste and/or fibres with water, for example by immersion, the drying may then be performed by known methods. Optionally, washing may comprise contacting the powder, granules, pellets, paste and/or fibres with an aqueous solution comprising an oxidant, such as hydrogen peroxide, sodium percarbonate, sodium perborate, sodium hypochlorite, calcium hypochlorite, potassium hypochlorite, chlorine dioxide, potassium chlorate, sodium chlorate, sodium perchlorate, potassium perchlorate, sodium chlorite or ozone; or with an aqueous solution comprising a base, such as lithium hydroxide, sodium hydroxide, potassium hydroxide, caesium hydroxide, magnesium hydroxide, calcium hydroxide, barium hydroxide, sodium carbonate, sodium bicarbonate, lithium carbonate, lithium bicarbonate, potassium carbonate, potassium bicarbonate caesium carbonate, caesium bicarbonate, sodium sulphate, sodium bisulphate, lithium sulphate, lithium bisulphate, potassium sulphate, potassium bisulphate, caesium sulphate or ammonia.

The dispersion of lignocellulosic biomass in the aqueous-based solvent useful for the present invention may also further comprise further recycled manmade materials formed from cellulosic fibres, for example paper, cardboard, rayon, viscose and lyocell. Such manmade materials include ethers or esters of cellulose, which can be obtained from the bark, wood or leaves of plants, or from other lignocellulosic biomass, and paper, textile industries are a source of such manmade cellulosic fibres. Wastepaper or textiles can provide a cheap and environmentally friendly source of manmade cellulosic fibres by recycling otherwise disused feedstocks.

The dispersion may be provided by combining the lignocellulosic biomass particulate, the one or more binders and the aqueous-based solvent in any order. It is believed that the one or more binders present in the dispersion bind together the lignocellulosic biomass, in order to maintain a cohesive material, and confer particularly desirable properties in the flexible material obtained. Preferably, the weight ratio of lignocellulosic biomass to total amount of the one or more binders is from 1:3 to 9:1, preferably from 1:2 to 9:1, more preferably, from 1:1 to 9:1, even more preferably from 1:1 to 5:1, even more preferably still, from 1:1 to 3:1, most preferably, from 1:1 to 2:1, for example 1.25:1.

Polysaccharides are polymers made up of a sugar repeating unit of a monosaccharide or disaccharide. A sulphated polysaccharide is a polysaccharide comprising sulphate groups. It has been surprisingly found that sulphated polysaccharides are particularly suited to acting as binders in the plant-based materials of the invention, providing a high degree of adhesion of the lignocellulosic biomass. Without being bound to any particular theory, it is thought that the sulphated polysaccharide has the ability to form a gel that is useful in binding the lignocellulosic biomass into a cohesive flexible material, thus imparting excellent physical properties onto the materials. Sulphated polysaccharides have been found by the inventors to act as superior binders in providing flexible materials according to the invention in comparison to non-sulphated polysaccharides. Sulphated polysaccharides are believed to act as superior gelling agents in the presence of lignocellulosic biomass because of their highly polarised and hydrogen bond accepting sulphate groups, resulting in tighter cohesion, and more desirable properties in the flexible materials derived therefrom. Sulphated polysaccharides are readily available from renewable and vegan sources and their use has significant advantages over traditional animal derived binders such as gelatine or lecithin.

The at least one sulphated polysaccharide may comprise from 0.5 to 3 sulphate groups per monosaccharide repeating unit and/or 1 to 6 sulphate groups per disaccharide repeating unit, preferably the at least one sulphated polysaccharide may comprise from 0.5 to 2 sulphate groups per monosaccharide repeating unit and/or 1 to 4 sulphate groups per disaccharide repeating unit, more preferably, the at least one sulphated polysaccharide may comprise from 0.5 to 1 sulphate groups per monosaccharide repeating unit and/or 1 to 2 sulphate groups per disaccharide repeating unit.

In some embodiments the at least one sulphated polysaccharide may comprise a sulphated polysaccharide having a helical structure, preferably wherein the at least one sulphated polysaccharide comprises a sulphated polysaccharide made up of repeating galactose units and 3,6 anhydrogalactose (3,6-AG), both sulphated and non-sulphated. Reference herein to a specified monosaccharide or disaccharide e.g. galactose or anhydrogalactose includes sulphated analogues of the monosaccharide or disaccharide when discussed in the context of a sulphated polysaccharide unless specifically stated otherwise. In some embodiments the at least one sulphated polysaccharide may comprise a carrageenan, a fucan, an ulvan, or combinations thereof.

Carrageenans are a family of linear sulphated polysaccharides that form single or double helical structures. Carrageenans comprise a helical structure of repeating galactose units and 3,6 anhydrogalactose (3,6-AG), both sulphated and non-sulphated, that are extracted from red edible seaweeds. There are three main varieties of carrageenan, which differ in their degree of sulphation. Kappa carrageenan has one sulphate group per disaccharide, iota carrageenan has two, and lambda carrageenan has three. The at least one sulphated polysaccharide may comprise any one of kappa carrageenan, iota-carrageenan, lambda-carrageenan or combinations thereof. Preferably, the at least one sulphated polysaccharide comprises kappa carrageenan and/or iota carrageenan. More preferably, the at least one sulphated polysaccharide comprises, or is, kappa carrageenan. Furcellaran, also known as Danish agar, is a partially sulphated polysaccharide of the carrageenan family comprising repeating units of both beta carrageenan and kappa carrageenan. Furcellaran thus bears a close structural similarity with kappa carrageenan but has a lower degree of sulphation. The at least one sulphated polysaccharide may comprise furcellaran, either alone or in combination with other sulphated polysaccharides. Furcellaran can be prepared by extraction from Furcellaria lumbricalis.

Sulphated fucans, also known as fucans, are a group of sulphated polysaccharides comprising repeating sulphated fucose units. Fucoidan is an example of a fucan of an average molecular weight of 20,000 Daltons, found mainly in various species of brown algae and brown seaweed. The at least one sulphated polysaccharide may comprise fucan, either alone or in combination with other sulphated polysaccharides, preferably the at least one sulphated polysaccharide may comprise fucoidan. Ulvan is a sulphated polysaccharide obtained from green algae and comprises sulphated rhamnose, glucuronic acid, iduronic acid, and xylose. The at least one sulphated polysaccharide may comprise ulvan, either alone or in combination with other sulphated polysaccharides.

The binder may also further comprise at least one non-sulphated polysaccharide and/or plant-based protein. Typical non-sulphated polysaccharides that may be present in the binder include agar, alginate, locust bean gum, Arabic gum, corn/rice/wheat starch, konjac gum, tragacanth gum, CMC Tylo/Tylose, xanthan gum and combinations thereof. The inclusion of a non-sulphated polysaccharides in the one or more binders is believed to provide improved mechanical properties to the resulting flexible material. In particular, locust bean gum and konjac gum are known to have a synergistic effect with carrageenan. In a preferred embodiment the one or more binders comprises carrageenan (e.g. kappa carrageenan) and agar. Agar also known as agar-agar, is a jelly-like substance, obtained from red algae. Agar consists of a mixture of two polysaccharides: agarose and agaropectin, with agarose making up about 70% of the mixture. Agarose is a linear polymer, made up of repeating units of agarobiose, a disaccharide made up of D-galactose and 3,6-anhydro-L-galactopyranose. Typical plant-based proteins that may be present in the binder include plant storage proteins, such as gliadin, glutelin, gluten, hemp protein, hordein, secalin, zein, kafirin and avenin. The inclusion of plant-based proteins in the one or more binders is believed to provide improved mechanical properties to the resulting flexible material.

The aqueous-based solvent comprises water, and may come from various sources, for example fresh water, salt water, grey water, or combinations thereof. It is advantageous to use grey water and/or saltwater as these are cheaply available. It is also environmentally beneficial to utilise wastewater supplies that may otherwise be discarded or require energy intensive water treatment before they can be reused, and to avoid unnecessarily using supplies of clean water. In addition to water, the aqueous-based solvent may further comprise a polar co-solvent. A polar co-solvent herein refers to any liquid that is miscible with water. Examples of polar co-solvents include carboxylic acids for example (formic acid, acetic acid, propanoic acid), acetone, acetonitrile, alcohols, tetrahydrofuran, or combinations thereof. Preferably, the polar co-solvent is an alcohol, more preferably the polar co-solvent is an alcohol selected from methanol, ethanol, propanol, butanol or combinations thereof.

With regard to step c) of the present methods, drying of the heated dispersion herein refers to removing a portion of the aqueous-based solvent as well as a portion of, or substantially all of, the polar co-solvent that is present to the extent that the pourable heated dispersion is transformed into a solid flexible material. Typically, the moisture content of the dried solid flexible material after drying is complete is less than 35% w/w, preferably less than 30% w/w, more preferably less than 25% w/w, most preferably less than 20% w/w. In other embodiments the moisture content of the dried solid flexible material after drying is from 10% to 30% w/w, preferably from 15% to 25% w/w.

With a dispersion provided in accordance with step a) of the methods disclosed herein, it will be appreciated that most of the lignocellulosic biomass component is not soluble in the aqueous-based solvent and that the one or more binders comprising at least one sulphated polysaccharide will be expected to be at least partially or substantially soluble in the aqueous-based solvent. A dispersion is a system in which distributed particles or fibres of one material are dispersed in a continuous phase of another material. The two phases in a dispersion may be in the same or different states of matter, although in the present invention the dispersion will comprise a solid phase (lignocellulosic biomass) and a liquid phase (aqueous-based solvent and dissolved binder component) and may optionally comprise further phases.

For example, the dispersion may comprise a gaseous phase. If the dispersion comprises a gaseous phase then it may also be defined as a foam. A foam is a system wherein a gaseous phase is dispersed throughout a liquid or solid phase. Therefore, a liquid phase with both a solid phase and a gaseous phase dispersed throughout it may be defined as both a dispersion and a foam simultaneously, thus the dispersion of step a) may optionally be a foam.

Optionally, the dispersion may also be a slurry. A slurry is a semi-liquid mixture, typically of fine particles suspended in an aqueous phase. Thus, in the case that sufficient lignocellulosic biomass is suspended in the aqueous phase so that the flowability of the dispersion is significantly reduced, the dispersion may be simultaneously defined as a dispersion and a slurry.

In some embodiments, a plasticiser is incorporated into the dispersion of lignocellulosic biomass in an aqueous-based solvent. A plasticiser is a substance that is added to a material to make it softer and more flexible. Preferably, the plasticiser is a polyol, more preferably wherein the plasticiser is selected from a monosaccharide, disaccharide, oligosaccharide or combinations thereof, even more preferably wherein the plasticiser is selected from maltitol, xylitol, erythritol, isomalt, arabitol, HSHs, lactitol, mannitol, glycerol, sorbitol and combinations thereof, most preferably the plasticiser is glycerol. In embodiments where the plasticiser is glycerol, preferably, the weight ratio of lignocellulosic biomass to glycerol in the dispersion is from 10:1, preferably from 5:1 to 1:1, more preferably from 3:1 to 1:1, even more preferably from 2:1 to 1:1.

Additionally or alternatively, one or more additional ingredients may be incorporated into the dispersion, for example, additives selected from crosslinkers, stabilisers, emulsifiers, preservatives, thickeners, perfumes, mechanical fillers, antibacterials, antifungals, insecticides, mica, minerals and combinations thereof may be incorporated into the dispersion. Additionally or alternatively, one or more essential oils may be incorporated into the dispersion, preferably wherein the essential oils are selected from spruce oil, pine oil, cinnamon leaf oil, fir oil, tea tree oil, peppermint oil, clove oil, thyme oil, oregano oil, rosemary oil, lavender oil, clary sage oil, arborvitae oil and combinations thereof.

Additionally or alternatively, one or more pigments may be incorporated into the dispersion preferably selected from zinc oxide, titanium dioxide, indigo, mica, algae and seaweed pigments (for example, spirulina), carbon black, vegetable plant derived pigments (for example, woad, weld, madder, marigold, dandelion, yarrow, sunflower, hibiscus, St John's Wort, Golden Rod, Dyer's Broom, Logwood, Henna, Safflower, Sandalwood, Sappanwood, Brazilwood, beetroot and turmeric).

As indicated above, the composition may also further comprise at least one crosslinker that is preferably able to form crosslinks between the sulphated polysaccharides. Optionally the crosslinker comprises a positively charged ion capable of forming an ionic interaction with a sulphated polysaccharide, such as an optionally substituted ammonium ion, an alkali metal ion or an alkaline earth metal ion, for example, ammonium, lithium, sodium, potassium, rubidium, caesium, magnesium, calcium or strontium ions. Optionally the crosslinker comprises a polycarboxylic acid for example, succinic acid, fumaric acid, malic acid, itaconic acid, oxalic acid, malonic acid, glutaric acid, adipic acid, propane-1,2,3-tricarboxylic acid, isocitric acid or citric acid, preferably wherein the polycarboxylic acid is citric acid.

The presence of either a gaseous phase dispersed in the aqueous phase or solvated gasses in the aqueous phase, for example nitrogen, oxygen, carbon dioxide, may lead to the formation of bubbles within the plant-based flexible material produced. Whilst not essential, it may be preferable to remove or avoid the formation of bubbles. Optionally, any bubbles that form after or during drying of the heated dispersion may be pierced (e.g. with a needle). Gasses may also be at least partially removed from the dispersion or the heated dispersion by degassing. Preferably, degassing comprises agitation of the dispersion. Agitation may comprise shaking a container holding the dispersion or heated dispersion, dropping a container holding the dispersion or heated dispersion, or any other physical agitation that causes trapped bubbles to be released. More preferably, the agitation comprises vibration of a container holding the dispersion or heated dispersion to release trapped bubbles and to desolvate dissolved gasses. Optionally degassing may also be achieved by sonication, sparging or chemical degassing of the dispersion or heated dispersion to release trapped bubbles and to desolvate dissolved gasses. Any of the degassing methods described herein may also be performed under vacuum or at reduced pressure.

Alternatively, in other embodiments the dispersion of step a) is provided as a foam and the bubbles may be maintained by omitting or limiting any of the above degassing processes. In such embodiments, the resulting flexible material may comprise air bubbles. A flexible material of the invention comprising air bubbles may be beneficial for use as thermal insulation due to reduced thermal conductivity of a flexible material comprising air bubbles. In some examples it may be preferable to include a step to actively introduce bubbles into the dispersion (for instance, in order to prepare a foam). Numerous known means are available for introducing bubbles into an aqueous phase, such as a blowing agent, foaming head or any other source of airflow.

The dispersion comprising the lignocellulosic biomass, aqueous-based solvent and the one or more binders is heated to at least 35° C. to form a heated dispersion. Typically, the dispersion comprising the lignocellulosic biomass will be heated at 100° C. or less. Preferably, the dispersion is heated at a temperature from 35° C. to 100° C., more preferably from 40° C. to 90° C., even more preferably from 40° C. to 80° C., most preferably from 50° C. to 60° C. As will be appreciated, heating temperature may need to be adjusted depending on the volume and dimensions of the dispersion being heated, which would be within the capabilities of the skilled person. Whilst there is no specific limitation necessary on the duration of heating, heating should be maintained for a suitable duration to allow the entire mixture to reach the desired temperature. Preferably the dispersion is heated for at least 1 minute, more preferably, the dispersion is heated for at least 3 minutes, even more preferably, the dispersion is heated for at least 5 minutes, even more preferably still, the dispersion is heated for at least 8 minutes, most preferably, the dispersion is heated for at least 10 minutes. Optionally the dispersion may be heated for between 1 minute and 30 minutes, preferably for between 3 minutes and 20 minutes, more preferably for between 5 minutes and 15 minutes. Some degree of mixing may be required during heating in order to ensure even heating, depending on the scale and the nature of the vessel holding the mixture. Mixing may be achieved with a hand mixer or an automated mixer. On the bench scale, heating and mixing may for example, be achieved using a standard cooking vessel such as a pan and hotplate, along with hand mixing. On an industrial scale, the heating may be achieved using for example, an industrial and/or self-mixing heating tank or reaction vessel.

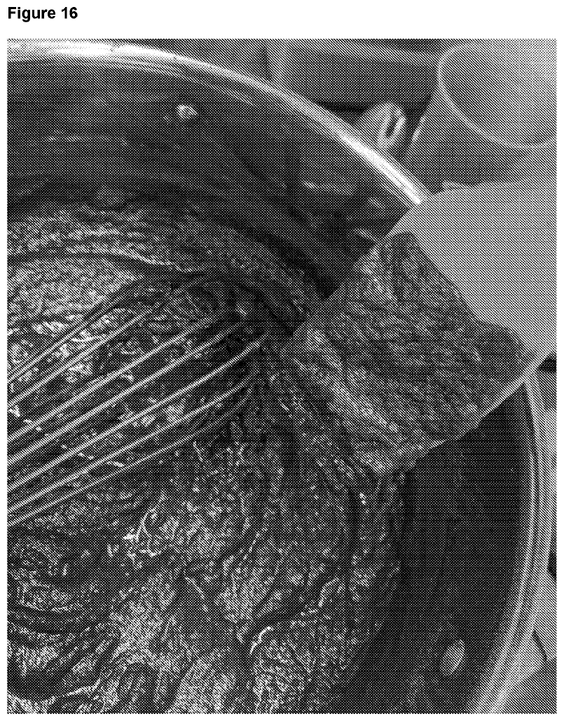

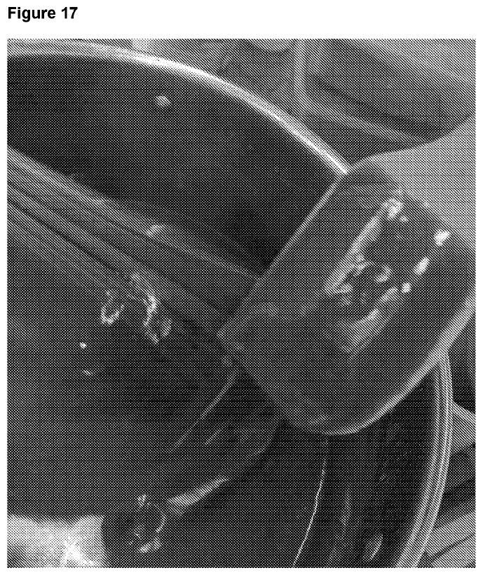

Without being limited to any particular theory, it is thought that gelation of the sulphated polysaccharide occurs as a result of heating, allowing the binder to further integrate the lignocellulosic biomass into a cohesive material by concentration of the gel into a solid as the aqueous-based solvent is removed during the subsequent drying step. The progress of gelation can, for instance, be measured using a dipstick—once gelation has occurred a film will typically be left on the dipstick after dipping into the gel. The gelling process is illustrated by FIGS. 16 and 17. FIG. 16 depicts a typical dispersion of lignocellulosic biomass provided in step a) prior to the heating provided in step b). FIG. 17 depicts the same dispersion after heating to 60° C. It can be seen that gelation has occurred as a result of heating and that the heated dispersion leaves behind a gelatinous film on a dipstick.

As will be appreciated the progress of the drying step can be monitored by a change in viscosity (gelling of the mixture can also be monitored by changes in viscosity, as the skilled person will appreciate), with drying having been completed typically once no more water is removed by the drying method. As would be appreciated, the removal of water during drying can be monitored by known non-destructive methods such as gravimetric analysis, measurement of electrical conductivity, measurement of the relative humidity of the surrounding atmosphere (for example, a humidity sensor may be present in a dehydration oven used for drying) or using any commercially available moisture meter (for example a Proster® model:PST131 wood moisture tester). Typically, the moisture content of the flexible material after drying is complete is less than 35% w/w, preferably less than 30% w/w, more preferably less than 25% w/w, most preferably less than 20% w/w. In other embodiments the moisture content of the dried solid flexible material after drying is from 10% to 30% w/w, preferably from 15% to 25% w/w.

The heated dispersion undergoes drying to remove a portion of the aqueous-based solvent as well as a portion of, or substantially all of, the polar co-solvent that is present to the extent that the pourable heated dispersion is transformed into a solid flexible material. Drying may be achieved by methods known in the art, for example the heated dispersion may be left to dry under ambient conditions, for instance at room temperature (i.e. at a temperature of from 20° C. to 25° C.) and/or atmospheric pressure, dried using exposure to airflow or turbulent air, dried in an oven using heating and/or fanning, or dried in a dehydrator. As will be appreciated, complete drying may be achieved using any combination of such drying methods (for example, leaving the heated dispersion to dry under ambient conditions initially, followed by drying by exposure to airflow or turbulent air and/or followed by oven drying). Further drying may also be achieved in combination with any of these methods by contacting a partially dried material with an absorbent material and optionally applying pressure to the partially dried material with the absorbent material. Drying may persist for anywhere between 1 hour and 72 hours, preferably from 6 hours to 24 hours.

The drying process yields a flexible material and so may be performed in a variety of methods in order to define the dimensions of the flexible material. Drying of the heated dispersion may take place on a surface in order for a sheet of flexible material to be formed, for example a flat surface such as a tray. Preferably, the surface may be the surface of a mould in order for the flexible material to be moulded into a desired shape, or the surface may be a surface of a substrate suitable for dip casting. In embodiments wherein the drying of the heated dispersion takes place on a surface, the heated dispersion is coated onto the surface prior to drying, and then dried to yield a flexible material of the desired dimensions dictated by the surface. Preferably, the resulting flexible material is coated onto the surface and dried such that the resulting flexible material has a thickness of from 0.01 mm to 10 mm. It will be appreciated that the initial thickness of the heated dispersion may differ from the thickness of the resulting flexible material formed by drying due to the removal of the aqueous-based solvent. In some embodiments the surface bearing the coating of the heated dispersion is exposed to turbulent air and/or a temperature of from 10° C. to 50° C., preferably from 20° C. to 40° C. in order to accelerate drying. Alternatively or additionally, the drying process may take place and/or begin to take place without direct contact with a surface, for example extrusion may be used to form a flexible material of a fixed cross-sectional profile, or additive manufacture may be used to create a flexible material of a complex structure.

In some embodiments, the process for preparing a plant-based flexible material further comprises surface treatment to modify properties. Preferably, the surface treatment improves the hydrophobicity of the surface. Increased hydrophobicity is advantageous as it prevents wetting of the plant-based flexible material which may encourage the growth of mould or other microorganisms, or otherwise degrade the material over time.

This treatment may take the form of chemically treating the surface and/or physically treating the surface. In some embodiments, one or more surfaces of the plant-based material may be coated with a composition comprising a free fatty acid and a plant-based triglyceride oil wherein the plant-based triglyceride oil is a drying-oil or a semi drying-oil curable in air. The free fatty acid acts as a softener which makes the surface more receptive to treatment with the triglyceride oil. The triglyceride oil imparts an attractive surface finish that provides hydrophobicity to the surface. Preferably the free fatty acid is stearic acid, which is particularly suitable as a softener for use in the present invention. Preferably, the volume ratio of free fatty acid to plant-based triglyceride oil in the composition is from 4:1 to 1:4, more preferably 2:1 to 1:2, even more preferably 1.5:1 to 1:1.5.

Plant-based triglyceride oils are tri-esters of glycerol that can be derived from plants. Triglyceride oils may be categorised into drying oils, semi-drying oils and non-drying oils depending on their ability to harden or cure to form a tough solid film after a period of exposure to air. The triglyceride oil hardens through a chemical reaction in which the components crosslink, and hence polymerise by reaction between oxygen and unsaturated carbon chains in the triglyceride oil. A drying oil is an oil that will harden to form a solid on exposure to oxygen, a semi-drying oil is an oil that will partially harden on exposure to oxygen and a non-drying oil is an oil that will not harden on exposure to oxygen.

The degree to which the triglyceride oil will harden or cure on exposure to oxygen therefore depends on the degree of unsaturation. The degree of unsaturation in a triglyceride oil can be quantified using the iodine value. Iodine value is the mass of iodine in grams that is consumed by 100 grams of the triglyceride oil. Iodine value thus demonstrates the degree of unsaturation by measuring the amount of iodine which is reacted with unsaturated carbon-carbon bonds. Iodine value is a standard test that would be within the knowledge and capabilities of the skilled person. Oils with an iodine value greater than 130 are considered to be drying oils, oils with an iodine value of from 115 to 130 are considered to be semi-drying oils and oils with an iodine value of less than 115 are considered to be non-drying oils. Examples of drying oils and semi-drying oils suitable for use in the present invention include tung oil, poppy seed oil, boiled linseed oil, perilla oil, walnut oil, palm butter, safflower oil, soybean oil, oiticica oil, perilla oil, candlenut oil, niger seed oil, tall oil, hemp oil, sesame oil, rapeseed oil, tobacco oil, rubber seed oil, manihot glaziovii oil, grape oil, cottonseed oil, corn oil, sesame oil, sunflower oil, rapeseed oil, colza oil, camelina oil, argemone oil and combinations thereof, preferably wherein the drying oil comprises boiled linseed oil. Boiled linseed oil may be generated by heating raw linseed oil near 300° C. for a few days in the complete absence of air. Under these conditions, the polyunsaturated fatty esters convert to conjugated dienes, which then undergo Diels-Alder reactions, leading to crosslinking. The product, which is highly viscous, gives highly uniform coatings that dry to more elastic coatings than linseed oil itself. Boiled linseed oil may also comprise metallic oil drying agents and raw linseed oil in addition to boiled linseed oil.

In some embodiments, the surface treatment may comprise coating of one or more surfaces with a composition comprising a plant based non-drying triglyceride wax which is not curable in air and a drying oil or semi drying oil as defined above. Preferably, the volume ratio of the drying oil or semi drying oil to the non-drying triglyceride wax is from 5:1 to 1:1, more preferably from 4:1 to 1:1, most preferably from 3:1 to 2:1. Preferably the triglyceride wax is selected from carnauba wax, rice bran wax, or soy wax. Triglyceride waxes are solid or highly viscous tri-esters of glycerol that contain no unsaturation or a low degree of unsaturation and thus do not dry on exposure to oxygen and are not drying oils or semi-drying oils as defined above. In some embodiments one or more surfaces are treated with both a composition comprising a free fatty acid and a plant-based triglyceride oil as defined above, and a composition comprising a plant based non-drying triglyceride wax which is not curable in air and a drying oil or semi drying oil as defined above. Surface treatment of the flexible material with an oil or wax as defined herein may optionally be utilised to provide further advantageous properties to the flexible material such as providing a more water repellent surface.

Alternatively or additionally, the surface treatment may comprise or further comprise physical modification, for example surface etching or texturing using plasma, a waterjet or lasers. Preferably the surface treatment comprises nanoscale laser surface texturing or nanoscale laser surface etching, preferably wherein the hydrophobicity of the surface is increased. Imparting hydrophobic nanostructure using laser etching or texturing can be achieved using known methods, for example those outlined in Jagdheesh, R et al, Langmuir 2011, 27, 13, 8464-8469.

Alternatively or additionally, the surface treatment may comprise or further comprise a pressing step, for example thermal pressing, hydraulic pressing and/or cold pressing. Preferably the pressing step comprises thermal pressing. The thermal pressing is performed at a temperature of from 35° C. to 100° C., preferably at a temperature from 40° C. to 90° C., more preferably from 40° C. to 80° C., most preferably from 50° C. to 60° C. Preferably, hydraulic pressing is performed at a pressure of 100 to 1,000 kNm⁻², more preferably from 400 to 800 kNm⁻². Pressing may be used to provide advantageous properties, for example a more consistent surface and thickness, or a more durable material with superior mechanical properties.

In some embodiments the process may comprise forming a flexible material having a particular structure. Examples of structures that can be formed from the flexible material include a sheet, a fabric, a coated fabric, a weave, a fibre, a wire, a ribbon, a rope, a rod, a mesh, a honeycomb, spheres, cylinders, or tubes. Sheets, fabrics and coated fabrics are particularly desirable structures as they have good applications in producing desirable articles such as shoes, clothing, fashion accessories, construction materials, fabrics (for example tents), vehicle interiors or seating (for example, cars, other road vehicles, aircraft or spacecraft) or upholstery. Some structures may be derived from the nature of the drying process of the heated dispersion, for example a sheet may be formed by drying the heated dispersion on a flat surface or a more complex structure may be formed by drying the heated dispersion in a mould. Wires or rods, for example, may be formed by drying the heated dispersion during extrusion. Other complex structures, for example a rope or a mesh may be built up from more simple structures formed as described above. In some embodiments, the process may further comprise cutting the flexible material, in order to form material of the desired dimensions.

Lamination herein refers to the process of attaching a layer of material to another layer of material in order to form a multi-layered material. Typically, lamination may be applied where the flexible material is provided in the form of a sheet. In some embodiments, the process of producing a plant-based flexible material may include the step of laminating a sheet of the flexible material to at least one further sheet of the same flexible material, at least one other sheet of a different embodiment of the flexible material of the present invention, another material and/or combinations thereof. Lamination of multiple layers of the flexible material of the present invention may be used to provide increased thickness and strength. Lamination of multiple layers of the flexible material of the present invention having differing properties (for example, having different surface treatments, differing methods of production or different sources of lignocellulosic biomass) may be used to impart unique combinations of properties onto the resulting material. Lamination may also be used to utilise a more visually appealing, or preferentially surface treated material on the exterior of an article whilst using a cheaper or more physically robust material on the interior. The combination of layers of the flexible material of the present invention with layers of other materials and/or combinations of materials may also be used to provide composite materials with a range of desirable properties in a similar fashion.

The processes disclosed herein may be performed as either a batch process or a continuous process. In embodiments wherein the process is a continuous process, the process may be uninterrupted for a significant amount of time with the components continuously in motion, undergoing chemical reactions and/or subject to mechanical or heat treatment. In embodiments wherein the process is a continuous process, a continuous output of the plant-based flexible material may be produced without interruption for a significant amount of time. In some embodiments, the continuous process may be run for over 24 hours without interruption, preferably for over 48 hours without interruption, more preferably for over 72 hours without interruption, more preferably for one week without interruption, more preferably for two weeks without interruption, more preferably for one month without interruption, more preferably for 2 months without interruption, more preferably for 3 months without interruption, more preferably for 6 months without interruption, most preferably for a year without interruption.

It will be appreciated that the processes described herein may be performed at a bench scale as well as at an industrial scale. The skilled person would be able to apply an appropriately scaled vessel for use in any process steps, for example, provision of the dispersion, mixing of the dispersion, heating of the dispersion, provision of the aqueous-based solvent, solvation of the one or more binders in the aqueous-based solvent, incorporation of any other component disclosed herein, and any other step performed as part of the methods disclosed herein. As will be appreciated, selecting appropriate temperatures from the ranges disclosed herein and appropriate timescales would depend on the scale of the process, it would be within the capabilities of the skilled person to adjust these parameters as is appropriate. Similarly, the choice of appropriate apparatus for use in steps such as drying, drying on a surface, moulding, dip-casting, degassing, and pressing will depend on the desired scale and could be determined by the skilled person. It will be appreciated that a continuous process, or aspects of a continuous process may be more suited to larger scale production.

The present invention also provides a plant-based flexible material comprising lignocellulosic biomass and one or more binders, wherein the one or more binders includes at least one sulphated polysaccharide, as described herein, which material may be prepared or preparable by the methods described herein. In some embodiments the plant-based flexible material may further comprise one or more plasticisers, one or more additional ingredients as defined above, one or more essential oils as defined above and/or one or more pigments as defined above. Alternatively and additionally, in some embodiments the plant-based flexible material may comprise one or more surfaces coated with a composition comprising a free fatty acid and a cured plant-based triglyceride oil as defined above, and/or may comprise one or more surfaces coated with a composition comprising a cured plant-based triglyceride oil as defined above and a non-drying triglyceride wax.

The flexible material of the present invention has also been found to be resistant to UV degradation and/or phototendering. The flexible material of the present invention can withstand a level of UV light that may be encountered in the course of the uses described herein without significant aging or colour change.

The present invention also provides a plant-based flexible material as defined above having at least one, preferably all, of the following properties, or any subset of the following properties:
an abrasion resistance as determined by BS EN ISO 12947-2:2016 of >5,000 martindales, preferably of >10,000 martindales, more preferably of >15,000 martindales, even more preferably of >20,000 martindales, most preferably of >30,000 martindales;
a finish adhesion strength as determined by BS EN ISO 11644:2009 of >2.0 N/10 mm, preferably of >3.0 N/10 mm, more preferably of >4.0 N/10 mm;
tear strength (non-woven) as determined by BS EN ISO 9073-4:1997 of >5 N, preferably of >10 N, more preferably of >15 N;
flexing crack resistance (wet) as determined by BS EN ISO 5402-1:2011 of no surface coating damage at 250 cycles, preferably of no surface coating damage at 375 cycles, more preferably of no surface coating damage at 500 cycles;
flexing crack resistance (dry) as determined by BS EN ISO 5402-1:2011 of no surface coating damage at 250 cycles, preferably of no surface coating damage at 375 cycles, more preferably of no surface coating damage at 500 cycles;
elongation as determined by BS EN ISO 3376:2011 of from 35% to 65%, preferably of from 65% to 80%, more preferably of >80%.
Shore strength as determined by ASTM D2240-00 having a value falling in the 00 scale to the D scale, preferably having a value falling in the 0 scale to the E scale, more preferably having a value falling in the M scale.

The present invention also provides an article comprising a plant based flexible material as defined above. For example, the article may be a shoe, a piece of clothing, a fashion accessory, construction material, a tent, a fabric, a vehicle interior or seat (for example, cars, other road vehicles, aircraft, or spacecraft) or a piece of upholstery.

The present invention also provides the use of a sulphated polysaccharide, preferably a carrageenan, more preferably one or more of furcellaran, kappa carrageenan or iota carrageenan, even more preferably kappa carrageenan, as a binder in a plant-based flexible material as defined above, and/or in an article comprising a plant-based flexible material as defined above.

The present invention will now be further described with reference to the below non-limiting examples.

### EXAMPLES

### Example 1—Preparation of a Plant-Based Flexible Material with Surface Treatment and Cold Pressing

The intact lignocellulosic biomass was shredded with a 1000 g stainless steel electric grain grinder and then washed by spinning in a trommel with either water, or a 3% aqueous solution of hydrogen peroxide. The washing step may also be omitted without noticeable difference to physical properties. The shredded lignocellulosic biomass was dehydrated in an oven at 50° C. for 24 to 48 hours and then ground into a fine powder using a 220 V commercial flour mill grains pulveriser. The powdered lignocellulosic biomass was sifted to ensure a maximum particle size of from 100 to 300 μm.

55 ml (16.5 g) of leaf powder (sifted to 100 to 300 μm), 55 ml (27.5 g) of Christmas tree powder (sifted to 100 to 300 μm) was mixed with 1200 ml of water, 50 ml of kappa carrageenan, 40 ml of glycerol, 5 drops of essential spruce oil or pine oil, 5 drops of cinnamon leaf oil and 1.25 ml of indigo, and was heated to 60° C. for 10 minutes. The mixture was then mixed for 3 minutes and then poured into a 390×390 mm tray and the tray placed on a vibrating bed to remove air bubbles. The mixture was then allowed to cool for 5 to 30 minutes at room temperature (approximately 21° C.) and then dried in a dehydrating fan oven at a temperature of up to 50° C. for 16 to 20 hours to form a sheet.

A 50/50 (v/v) mix of stearic acid and pure boiled linseed oil was applied to the sheet on both sides to soften the surface and prevent material fatigue from flexing, any excess oil was wiped off with a smooth cloth. A 70/30 (v/v) mix of pure boiled linseed oil and carnauba wax was applied to the sheet on both sides, to further repel water and increase surface strength, any excess wax/oil mixture was wiped off with a smooth cloth.

The sheets were cold pressed with a hand-operated 610 mm sheet metal roller. The pressure was increased incrementally by hand. A textured sheet may be placed between the material and the press and rolled through, to transfer a texture or pattern onto the material.

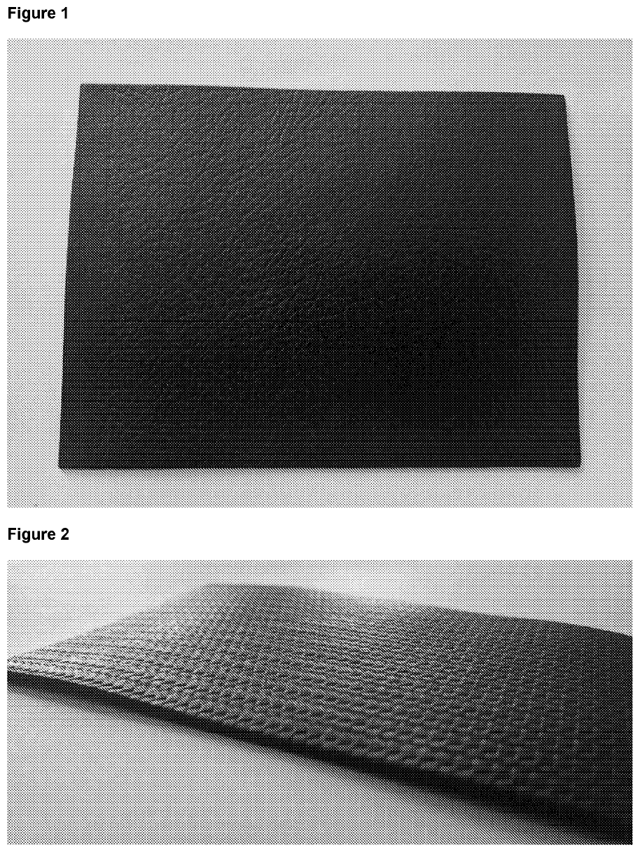

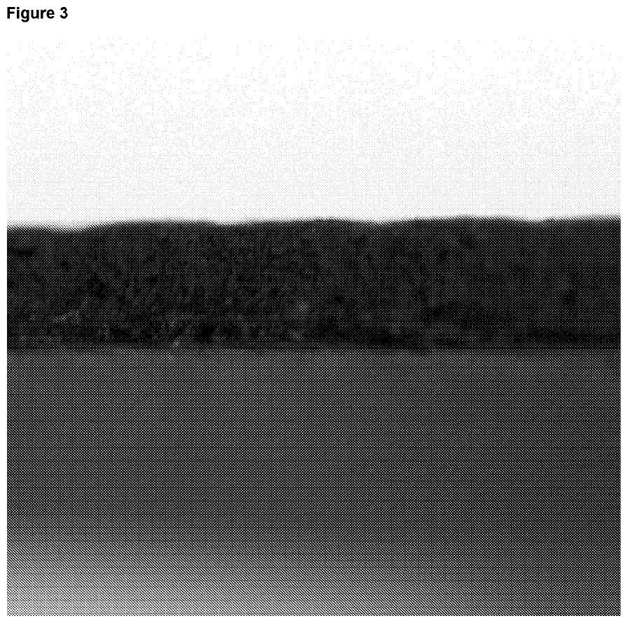

The material prepared by the above method is illustrated by FIGS. 1 to 5. FIG. 1 shows a sheet of flexible material produced by the above method. FIG. 2 shows the other side of the material, showcasing the sheen produced by the surface finish. Both FIGS. 1 and 2 illustrate surface texturing/patterning that can be produced during pressing with a textured sheet. FIG. 3 illustrates a cross sectional view of the material from which the effect of surface treatment can be observed.

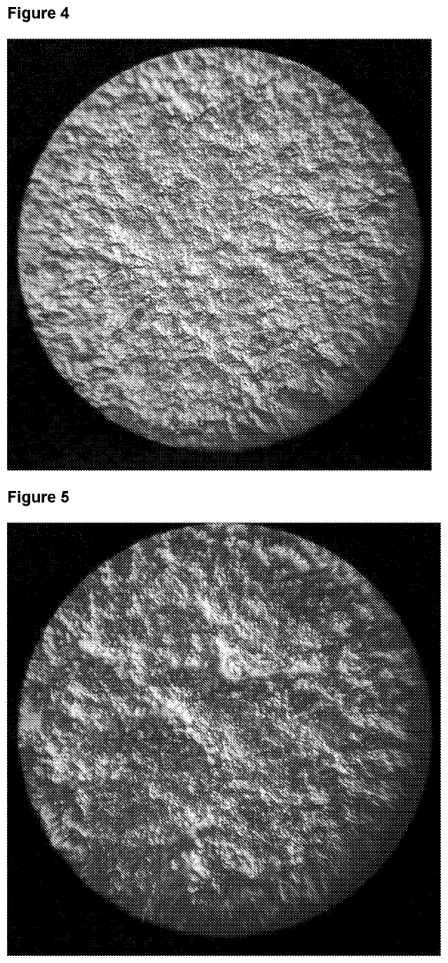

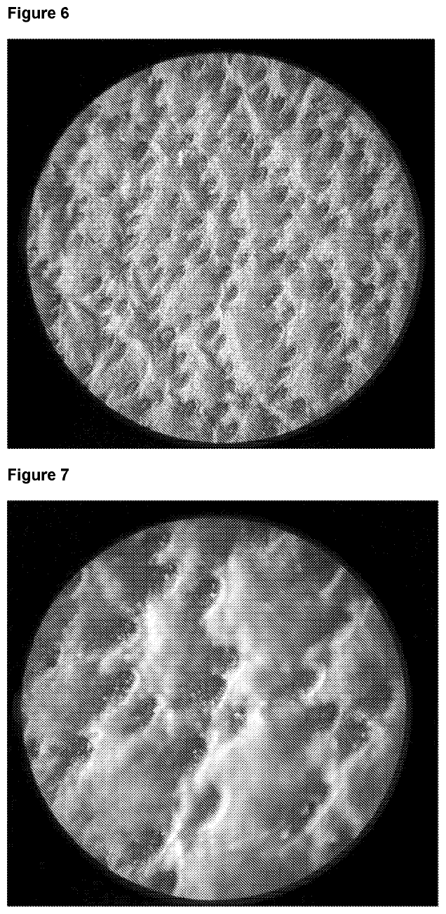

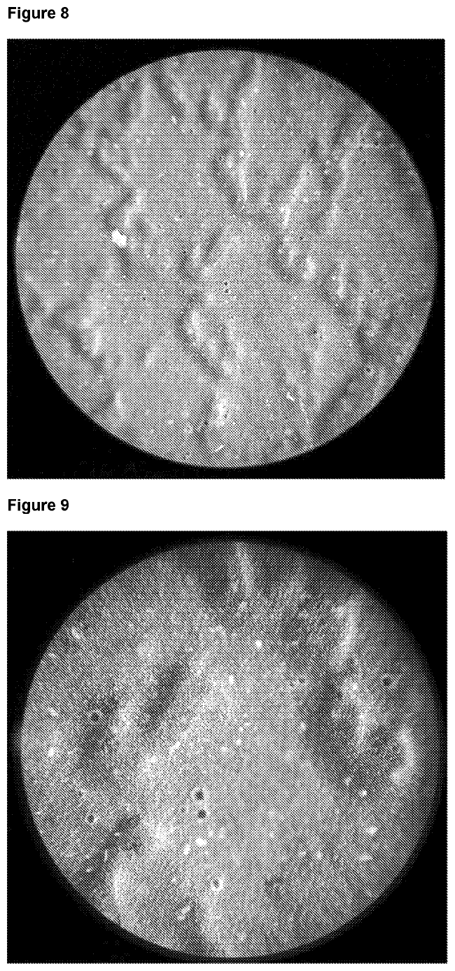

FIGS. 4 and 5 illustrate the material produced by the method of Example 1 at ×40 magnification and at ×100 magnification, respectively. Visible differences in the structure of the present plant-based flexible material can be clearly observed when comparison is made to the comparative animal leather and PVC leather samples illustrated by FIGS. 6 to 9. FIGS. 6 and 7 illustrate a comparative example of animal leather at ×40 magnification and at ×100 magnification, respectively. FIGS. 8 and 9 illustrate a comparative example of PVC leather at ×40 magnification and at ×100 magnification, respectively.

### Example 2—Preparation of Plant-Based Flexible Material

The intact lignocellulosic biomass was shredded with a 1000 g stainless steel electric grain grinder and then washed by spinning in a trommel with either water, or a 3% aqueous solution of hydrogen peroxide. The washing step may also be omitted without noticeable difference to physical properties. The shredded lignocellulosic biomass was dehydrated in an oven at 50° C. for 24 to 48 hours and then ground into granules using a 220 V commercial flour mill grains pulveriser. The granular lignocellulosic biomass was not sifted and had a particle size of up to approximately 4000 μm. 55 ml (16.5 g) of leaf granules 4000 μm), 55 ml (27.5 g) of Christmas tree granules 4000 μm) was mixed with 1200 ml of water, 50 ml of kappa carrageenan, 40 ml of glycerol, 5 drops of essential spruce oil or pine oil, 5 drops of cinnamon leaf oil, 1.25 ml of indigo, and was heated to 60° C. for 10 minutes. The mixture was then mixed for 3 minutes and then poured into a 390×390 mm tray and the tray placed on a vibrating bed to remove air bubbles. The mixture was then allowed to cool for 5 to 30 minutes at room temperature (approximately 21° C.) and then dried in a dehydrating fan oven at a temperature of up to 50° C. for 16 to 20 hours to form a sheet.

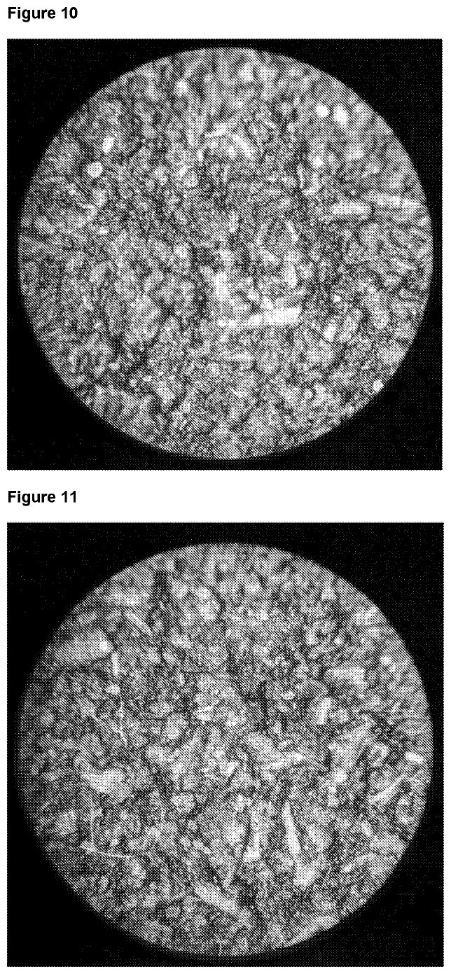

FIGS. 10 and 11 illustrate the material produced by the above method at ×40 magnification and at ×100 magnification, respectively. In this method, both pressing and surface treatment were omitted and larger lignocellulosic biomass granules of up to 4000 μm were utilised. The effects of larger lignocellulosic biomass particle size can be observed in the rougher appearance of the surface under magnification. The physical properties were not significantly impacted by the change in particle size.

### Example 3—Preparation of a Plant-Based Flexible Material Corresponding with Cold Pressing

The intact lignocellulosic biomass was prepared as per Example 1.

55 ml (16.5 g) of leaf powder (sifted to 100 to 300 μm), 55 ml (27.5 g) of Christmas tree powder (sifted to 100 to 300 μm) was mixed with 1200 ml of water, 50 ml of kappa carrageenan, 40 ml of glycerol, 5 drops of essential spruce oil or pine oil, 5 drops of cinnamon leaf oil, 1.25 ml of indigo, and was heated to 60° C. for 10 minutes. The mixture was then mixed for 3 minutes and then poured into a 390×390 mm tray and the tray placed on a vibrating bed to remove air bubbles. The mixture was then allowed to cool for 5 to 30 minutes at room temperature (approximately 21° C.) and then dried in a dehydrating fan oven at a temperature of up to 50° C. for 16 to 20 hours to form a sheet.

The sheets were cold pressed with a hand-operated 610 mm sheet metal roller. The pressure was increased incrementally by hand. A textured sheet may be placed between the material and the press and rolled through, to transfer a texture or pattern onto the material.

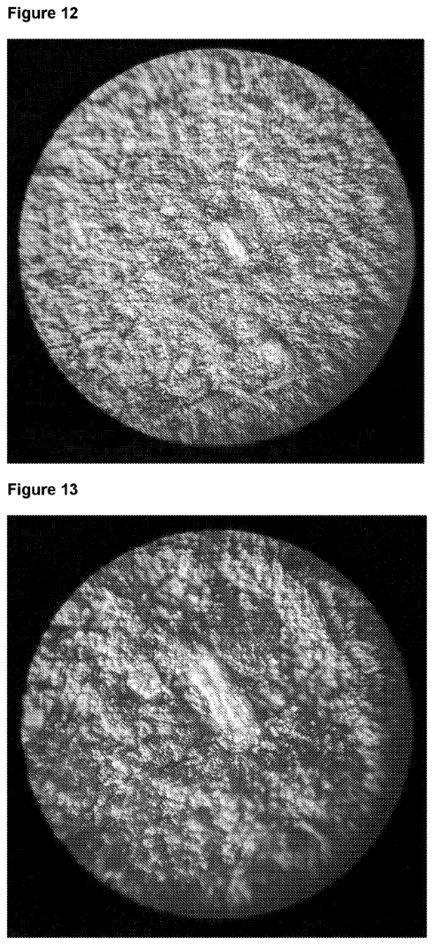

FIGS. 12 and 13 illustrate the material produced by the above method at ×40 magnification and at ×100 magnification, respectively. In the absence of surface treatments, the surface is observed to be slightly rougher than that of FIGS. 4 and 5.

### Example 4—Preparation of a Plant-Based Flexible Material with Hot Hydraulic Pressing

The intact lignocellulosic biomass was shredded with a 1000 g stainless steel electric grain grinder and then washed by spinning in a trommel with either water, or a 3% aqueous solution of hydrogen peroxide. The washing step may also be omitted without noticeable difference to physical properties. The shredded lignocellulosic biomass was dehydrated in an oven at 50° C. for 24 to 48 hours and then ground into a fine powder using a 220 V commercial flour mill grains pulveriser. The powdered lignocellulosic biomass was sifted to ensure a maximum particle size of 500 μm.

55 ml (16.5 g) of leaf powder (sifted to 500 μm), 55 ml (27.5 g) of Christmas tree powder (sifted to 500 μm) was mixed with 1200 ml of water, 50 ml of kappa carrageenan, 40 ml of glycerol, 5 drops of essential spruce oil or pine oil, 5 drops of cinnamon leaf oil, 9.5 g of titanium dioxide, and was heated to 60° C. for 10 minutes. The mixture was then mixed for 3 minutes and then poured into a 390×390 mm tray and the tray placed on a vibrating bed to remove air bubbles. The mixture was then allowed to cool for 5 to 30 minutes at room temperature (approximately 21° C.) and then dried in a dehydrating fan oven at a temperature of up to 50° C. for 16 to 20 hours to form a sheet.

The sheets were then pressed with a heated hydraulic press at 70° C. to a thickness of 3 to 4 mm at a pressure of 3 tonnes. It will be appreciated by the skilled person that the temperature of the heat press may be adjusted depending on the desired thickness.

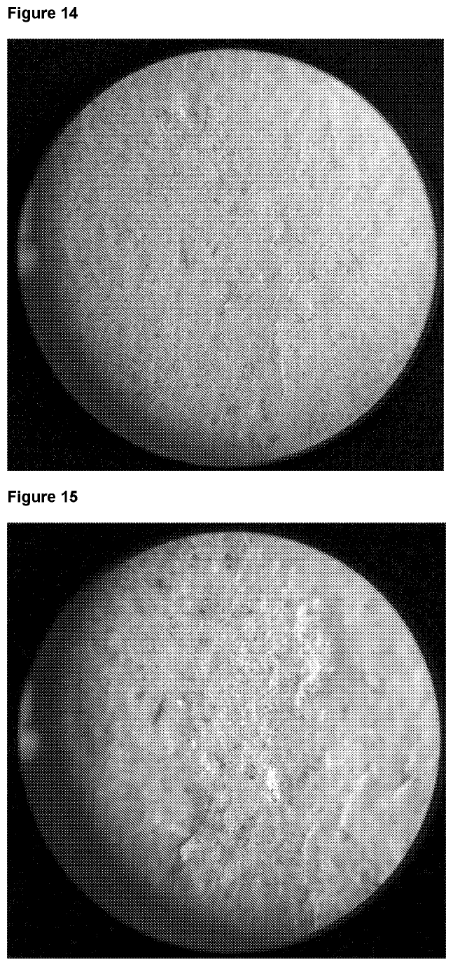

FIGS. 14 and 15 illustrate the material produced by the method of Example 4 at ×40 magnification and at ×100 magnification, respectively. It can be observed that high temperature hydraulic pressing produces a smoother surface than cold pressing or no pressing. Although not visible in the appended figures, addition of titanium dioxide affords a much whiter colouration to the material. Whilst not shown in the appended figures, other pigments such as blue mica, indigo, orange food colouring and blue food colouring have been demonstrated to similarly affect colouration.

### Example 5—Scaled Up Preparation of a Plant-Based Flexible Material

The intact lignocellulosic biomass was prepared as per Example 1.

110 ml (33 g) of leaf powder (sifted to 100 to 300 μm), 110 ml (55 g) of Christmas tree powder (sifted to 100 to 300 μm) was mixed with 2400 ml of water, 100 ml of kappa carrageenan, 80 ml of glycerol, 10 drops of essential spruce oil, 10 drops of essential pine oil, 10 drops of cinnamon leaf oil, 2.5 ml of indigo, and was heated to 60° C. for 10 minutes. The mixture was then mixed for 3 minutes and then poured into trays and placed in a dehydrating fan oven at a temperature of up to 50° C.

The tray was shaken slightly, and the tray was dropped from approximately 10 cm above the counter to level out and remove air bubbles. Remaining air bubbles were pierced with a needle. The mixture was allowed to cool for 30 minutes at room temperature (approximately 21 degrees). 15 ml of pure boiled linseed oil was applied to the sheets on both sides to soften the surface.

When the method is carried out on a larger scale the properties of the resulting flexible material were not negatively impacted.

### Example 6—Larder Scaled Up Preparation of a Plant-Based Flexible Material

The intact lignocellulosic biomass was prepared as per Example 1.

300 ml (90 g) of leaf powder (sifted to 100 to 300 μm), 300 ml (150 g) of Christmas tree powder (sifted to 100 to 300 μm) was mixed with 8000 ml of water, 250 ml of kappa carrageenan, 200 ml of glycerol, 15 drops of essential spruce oil, 15 drops of essential pine oil, 15 drops of cinnamon leaf oil, 15 ml (63.5 g) of titanium dioxide, and 20 ml of blue-green spirulina and was heated to 60° C. for 10 minutes. The mixture was then mixed for 3 minutes and then poured into trays and placed in a dehydrating fan oven at a temperature of up to 50° C.

The tray was shaken slightly, and the tray was dropped from approximately 10 cm above the counter to level out and remove air bubbles. Remaining air bubbles were pierced with a needle. The mixture was allowed to cool for 30 minutes at room temperature (approximately 21 degrees). 60 ml of pure boiled linseed oil was applied to the sheets on both sides to soften the surface and the surface was brushed with vinegar to prevent mould growth.

When the method is carried out on a larger scale the properties of the resulting flexible material were not negatively impacted. Addition of titanium dioxide produced a white colouration to the material.

### Example 7—Preparation of a Plant-Based Flexible Material at Higher Dispersion Concentration

The intact lignocellulosic biomass was prepared as per Example 1.

40 ml (12 g) of leaf powder (sifted to 100 to 300 μm), 20 ml (10 g) of Christmas tree powder (sifted to 100 to 300 μm) was mixed with 500 ml of water, 25 ml of kappa carrageenan, 20 ml of glycerol, 3 drops of cinnamon leaf oil, 1 ml of sodium silicate, and was heated to 60° C. for 10 minutes. The mixture was then mixed for 3 minutes and then poured into trays and placed in a dehydrating fan oven at a temperature of up to 50° C.

The tray was shaken slightly, and the tray was dropped from approximately 10 cm above the counter to level out and remove air bubbles. Remaining air bubbles were pierced with a needle. The mixture was allowed to cool for 30 minutes at room temperature (approximately 21 degrees). 5 ml of pure boiled linseed oil was applied to the sheets on both sides to soften the surface.

The properties of the resulting material were not negatively impacted by reducing the ratio of water to lignocellulosic biomass present in the dispersion.

### Example 8—Preparation of a Further Plant-Based Flexible Material

The intact lignocellulosic biomass was prepared as per Example 1.

55 ml (16.5 g) of leaf powder (sifted to 100 to 300 μm), 55 ml (27.5 g) of Christmas tree powder (sifted to 100 to 300 μm) and 10 ml (5 g) of plane bark powder was mixed with 1200 ml of water, 50 ml of kappa carrageenan, 40 ml of glycerol, 10 drops of essential spruce oil, 10 drops of essential pine oil, 5 drops of cinnamon leaf oil, 0.63 ml of indigo, 15 ml of boiled linseed oil and was heated to 60° C. for 8 minutes. The mixture was then mixed for 1 minute and then poured into a 380×380 mm tray and allowed to cool at room temperature.

The tray was shaken slightly, and the tray was dropped from approximately 10 cm above the counter to level out and remove air bubbles. Remaining air bubbles were pierced with a needle. The mixture was allowed to cool for 30 minutes in room temperature (approximately 21° C.).

### Example 9—Preparation of a Plant-Based Flexible Material Using a Carrageenan and Xanthan Binders

The intact lignocellulosic biomass was prepared as per Example 1.

50 ml (15 g) of leaf powder (sifted to 100 to 300 μm), was mixed with 1200 ml of water, 25 ml of glycerol and either 10 ml, 15 ml or 20 ml of both kappa carrageenan and xanthan, and was heated to 60° C. for 10 minutes. The mixture was then mixed for 3 minutes and then poured into a tray. The mixture was then allowed to cool for 5-30 minutes in at room temperature (approximately 21° C.) and then dried in a dehydrating fan oven without heating for 15 hours to form a sheet.

### Example 10—Methods of Drying the Heated Dispersion

The intact lignocellulosic biomass was prepared as per Example 1.

30 ml (9 g) of leaf powder (sifted to 100 to 300 μm), was mixed with 300 ml of water, 12.5 ml of kappa carrageenan, 10 ml of glycerol, 4 ml of linseed oil and was heated to 60° C. for 8 minutes. The mixture was then mixed for 1 minute.

The heated mixture was then poured into a 26.5×19 mm tray. The tray was shaken slightly, and the tray was dropped from approximately 10 cm above the counter to level out and remove air bubbles. Remaining air bubbles were pierced with a needle. The mixture was allowed to cool for 30 minutes at room temperature (approximately 21 degrees). The material was separated into rectangles (12.5×9 cm, 6.5 cm thick).

Methods of drying the rectangles were tested. Rectangles were dried at room temperature, drying was achieved after 48 hours. Rectangles were dried in an oven on the fan setting without any heating, drying was achieved after 24 hours. Rectangles were dried in a dehydrator using a fan and heating at 35° C., drying was achieved after 12 hours. Oven and room temperature drying provides similar moisture levels, resulting in lower flexibility. Drying in a dehydrator provides a lower moisture level, making the material more flexible.

1. A process for preparing a plant-based flexible material, comprising the steps of:
a) providing a dispersion of lignocellulosic biomass in an aqueous-based solvent and further comprising one or more binders, wherein the one or more binders comprises at least one sulphated polysaccharide;
b) heating the dispersion to a temperature of at least 35° C. to form a heated dispersion; and
c) drying the heated dispersion to form the flexible material.

2. The process of claim 1, comprising a preceding step wherein the lignocellulosic biomass is processed to be in the form of powder, granules, pellets, paste and/or fibres, and is combined with the aqueous-based solvent to provide the dispersion.

3. The process of claim 2, wherein the lignocellulosic biomass is in the form of: powder having a mean (d50) particle size of less than 1000 μm, preferably of less than 800 μm, more preferably of less than 700 μm, even more preferably of less than 600 μm, even more preferably of less than 500 μm, even more preferably of from 50 μm to 500 μm, most preferably of from 100 μm to 300 μm; and/or granules having a median (d50) particle size of from 1000 μm to 5,000 μm.

4. The process of claim 2, wherein the lignocellulosic biomass powder is washed and dried prior to combination with the aqueous-based solvent, preferably wherein washing comprises combining the lignocellulosic biomass with an aqueous hydrogen peroxide solution.

5. The process of claim 1, wherein the lignocellulosic biomass comprises leaves/needles, bark, twigs/branches, wood chips, grass, roots, flowers, seeds, stalks, stems, strobili, lignocellulosic food manufacturing waste, or combinations thereof, preferably wherein the lignocellulosic biomass comprises leaves/needles and/or twigs/branches, more preferably wherein the lignocellulosic biomass comprises leaves/needles and twigs/branches with a weight ratio of from 10:1 to 1:10.

6. The process of claim 1, wherein the aqueous-based solvent further comprises a polar co-solvent selected from alcohol, such as methanol, ethanol, propanol, butanol and combinations thereof.

7. The process of claim 1, wherein the dispersion provided in step a) is a foam or slurry.

8. The process of claim 1, wherein the dispersion or heated dispersion is degassed to at least partially remove bubbles or solvated gasses, preferably wherein the degassing comprises agitation of the dispersion or heated dispersion, more preferably wherein the agitation is achieved by vibration.

9. The process of claim 1, wherein the process comprises forming a sheet, a fabric, a coated fabric a weave, a fibre, a wire, a ribbon, a rope, a rod, a mesh, a honeycomb, spheres, cylinders, or tubes from the flexible material, preferably wherein the process comprises forming a sheet, a fabric or a coated fabric from the flexible material.

10. The process of claim 1, wherein the dispersion is heated in step b) at a temperature of from 35° C. to 100° C., preferably from 40° C. to 90° C., more preferably from 40° C. to 80° C., most preferably from 50° C. to 70° C.

11. The process of claim 1, wherein step c) further comprises coating the heated dispersion of step b) on to a surface prior to the drying, preferably to a thickness of from 0.01 to 10 mm.

12. The process of claim 11, wherein the surface is the surface of a mould, or is a surface for dip casting.

13. The process of claim 1, further comprising chemically surface treating the flexible material.

14. The process of claim 13, wherein the surface treatment comprises coating one or more surfaces of the flexible material with a composition comprising a free fatty acid and a plant-based triglyceride oil, wherein the plant-based triglyceride oil is a drying-oil or a semi drying-oil curable in air, wherein the volume ratio of free fatty acid to plant-based triglyceride oil in the composition is from 4:1 to 1:4, preferably 2:1 to 1:2, more preferably 1.5:1 to 1:1.5, preferably wherein the free fatty acid is stearic acid.

15. The process of any one of claim 14, wherein the surface treatment further comprises coating the flexible material with a composition comprising a plant based non-drying triglyceride wax which is not curable in air and a plant-based triglyceride oil, wherein the plant-based triglyceride oil is a drying-oil or a semi drying-oil curable in air; wherein the volume ratio of the drying oil or semi drying oil to the non-drying triglyceride wax is from 5:1 to 1:1, preferably 4:1 to 1:1, more preferably 3:1 to 2:1, preferably wherein the triglyceride wax is carnauba wax, rice bran wax, or soy wax.

16. The process of claim 14, wherein the drying oil or semi-drying oil is selected from boiled linseed oil, tung oil, poppy seed oil, perilla oil, walnut oil, palm butter, safflower oil, soybean oil, oiticica oil, perilla oil, candlenut oil, niger seed oil, tall oil, hemp oil, sesame oil, rapeseed oil, tobacco oil, rubber seed oil, manihot glaziovii oil, grape oil, cottonseed oil, corn oil, sesame oil, sunflower oil, rapeseed oil, colza oil, camelina oil, argemone oil and combinations thereof, preferably wherein the drying oil comprises boiled linseed oil.

17. The process of claim 13, wherein the surface treatment comprises pressing the flexible material with a press, preferable wherein the pressing comprises thermal pressing, hydraulic pressing and/or cold pressing.

18. The process of claim 17, wherein the press is a thermal press and the pressing step is performed at a temperature of from 35° C. to 100° C., preferably from 60° C. to 80° C. and/or the press is a hydraulic press and the pressing step is performed at a pressure of 100 to 1,000 kNm⁻², preferably from 400 to 800 kNm⁻².

19. The process of claim 1, wherein the process further comprises an additional step of nanoscale laser surface texturing or nanoscale laser surface etching, preferably wherein the hydrophobicity of the surface is increased.

20. The process of either of claim 1, wherein the dispersion provided in step a) further comprises manmade cellulosic fibres, such as paper, cardboard, rayon, viscose and lyocell.

21. The process of claim 1, wherein the aqueous solvent comprises fresh water, salt water, grey water, or combinations thereof.

22. The process of claim 1, wherein the volume ratio of aqueous solvent to lignocellulosic biomass in the dispersion provided in step a) is from 5:1 to 20:1, preferably from 10:1 to 15:1.

23. The process of claim 1 wherein the at least one sulphated polysaccharide comprises a sulphated polysaccharide having a helical structure, preferably wherein the at least one sulphated polysaccharide comprises a sulphated polysaccharide made up of repeating galactose units and 3,6 anhydrogalactose (3,6-AG), both sulphated and non-sulphated.

24. The process of claim 1, wherein at least one sulphated polysaccharide comprises a carrageenan, a fucan, an ulvan, or combinations thereof.

25. The process of claim 23, wherein the at least one sulphated polysaccharide comprises furcellaran, kappa carrageenan, iota carrageenan, and/or lambda carrageenan, preferably wherein the at least one sulphated polysaccharide comprises kappa carrageenan, more preferably wherein the at least one sulphated polysaccharide comprises kappa carrageenan and agar.

26. The process of claim 1, wherein the one or more binders further comprises at least one non-sulphated polysaccharide preferably wherein the one or more binders further comprises at least one non-sulphated polysaccharide selected from an alginate, locust bean gum, Arabic gum, corn/rice/wheat starch, konjac gum, tragacanth gum, CMC Tylo/Tylose, xanthan gum and combinations thereof.

27. The process of claim 1, wherein the weight ratio of lignocellulosic biomass to total amount of the one or more binders is from 1:3 to 9:1, preferably from 1:2 to 9:1, more preferably, from 1:1 to 9:1, even more preferably from 1:1 to 5:1, even more preferably still, from 1:1 to 3:1, most preferably, from 1:1 to 2:1, for example 1.25:1.

28. The process of claim 1, wherein a plasticiser is incorporated into the dispersion formed in step a), preferably wherein the plasticiser is a polyol, more preferably wherein the plasticiser is selected from a monosaccharide, disaccharide, oligosaccharide or combinations thereof, even more preferably wherein the plasticiser is selected from maltitol, xylitol, erythritol, isomalt, arabitol, HSHs, lactitol, mannitol, glycerol, sorbitol and combinations thereof, most preferably the plasticiser is glycerol.

29. The process of claim 28, wherein the plasticiser is glycerol and the weight ratio of lignocellulosic biomass to glycerol in the dispersion is from 10:1, preferably from 5:1 to 1:1, more preferably from 3:1 to 1:1, even more preferably from 2:1 to 1:1.

30. The process of claim 1, wherein:
i) one or more additional ingredients is incorporated into the dispersion provided in step a) selected from stabilisers, emulsifiers, preservatives, thickeners, perfumes, mechanical fillers, antibacterials, antifungals, insecticides, mica, minerals and combinations thereof; and/or
ii) wherein one or more essential oils are incorporated into the dispersion provided in step a), preferably wherein the one or more essential oils are selected from spruce oil, pine oil, cinnamon leaf oil, fir oil, tea tree oil, peppermint oil, clove oil, thyme oil, oregano oil, rosemary oil, lavender oil, clary sage oil, arborvitae oil and combinations thereof; and/or
iii) wherein one or more pigments are incorporated into the dispersion provided in step a), preferably wherein the one or more pigments are selected from zinc oxide, titanium dioxide, indigo, mica, algae and seaweed pigments (for example, spirulina), carbon black, plant derived pigments (for example, woad, weld, madder, marigold, dandelion, yarrow, sunflower, hibiscus, St John's Wort, Golden Rod, Dyer's Broom, Logwood, Henna, Safflower, Sandalwood, Sappanwood, Brazilwood, beetroot and turmeric); and/or
iv) wherein one or more crosslinkers are incorporated into the dispersion provided in step a), preferably wherein the one or more crosslinkers comprises positively charged ions and/or a polycarboxylic acid, preferably wherein the polycarboxylic acid is citric acid.

31. The process of claim 1, further comprising the step of laminating the flexible material to at least one further sheet of a flexible material according to any one of the preceding claims, and/or another material.

32. The process of claim 1, wherein the flexible material is used to prepare clothing, shoes, fashion accessories, construction materials, fabrics, vehicle interiors or seating, and/or upholstery, preferably wherein the flexible material is used to prepare, shoes, upholstery, vehicle interiors or seating, and/or fashion accessories.

33. The process of claim 1, wherein the process is operated continuously.

34. A plant-based flexible material prepared, or preparable, by the process of claim 1.

35. A plant-based flexible material comprising lignocellulosic biomass, one or more binders, and optionally further comprising one or more plasticisers, wherein the one or more binders includes at least one sulphated polysaccharide.

36. The plant-based flexible material of claim 35, having at least one, preferably all, of the following properties:
a) an abrasion resistance of >30,000 martindales as determined by BS EN ISO 12947-2:2016;
b) finish adhesion strength of >4.0 N/10 mm, as determined by BS EN ISO 11644:2009; and
c) tear strength (non-woven) of >15 N, as determined by BS EN ISO 9073-4:1997.

37. The plant-based flexible material of claim 35, wherein at least one of (a) the one or more binders are as defined in claim 23, and (b) the plasticiser is as defined in claim 28.

38. The plant-based flexible material of claim 35, wherein the material has a surface coating comprising: i) a free fatty acid and a plant-based triglyceride oil, wherein the plant-based triglyceride oil is a cured drying-oil or semi-drying oil; and/or ii) a surface coating comprising a plant-based triglyceride oil, wherein the plant-based triglyceride oil is a cured drying-oil or semi-drying oil, and a plant based non-drying triglyceride wax, preferably wherein the cured drying-oil or semi-drying oil is selected from boiled linseed oil, tung oil, poppy seed oil, perilla oil, and walnut oil, palm butter, safflower oil, soybean oil, oiticica oil, perilla oil, candlenut oil, niger seed oil, tall oil, hemp oil, sesame oil, rapeseed oil, tobacco oil, rubber seed oil, manihot glaziovii oil, grape oil, cottonseed oil, corn oil, sesame oil, sunflower oil, rapeseed oil, colza oil, camelina oil, argemone oil; and preferably wherein the non-drying triglyceride wax is carnauba wax rice bran wax, or soy wax; and preferably wherein the free fatty acid is stearic acid.

39. An article comprising the plant-based flexible material of claim 34, wherein the article is a shoe, a piece of clothing, a fashion accessory, construction material, a tent, a fabric, a vehicle interior or seat, a piece of upholstery preferably wherein the article is a shoe, upholstery, a vehicle interior or seat, or a fashion accessory.

40. Use of a sulphated polysaccharide, preferably kappa carrageenan, as a binder in a plant-based flexible material.
